(19) United States
(12) Patent Application Publication
(10) Pub. No.: US 2010/0121641 A1
(43) Pub. Date: May 13, 2010

(54) EXTERNAL VOICE IDENTIFICATION SYSTEM AND IDENTIFICATION PROCESS THEREOF

(75) Inventors: TSUNG-HAN TSAI, Taipei City (TW); Chen-Wei Su, Taipei City (TW); Chun-Ping Fang, Taipei City (TW); Min-Ching Wu, Taipei City (TW)

Correspondence Address: AIBELIVE CO., LTD., P.O.BOX 108-00403, TAIPEI, 106, omitted

(73) Assignee: AIBELIVE CO., LTD, Taipei City (TW)

(21) Appl. No.: 12/268,449

(22) Filed: Nov. 11, 2008

(51) Int. Cl. G10L 15/14

(52) U.S. Cl. 704/246; 704/E15.001

(57) ABSTRACT

An external voice identification system and an identification process thereof is disclosed. The external voice identification system of a multimedia electronic device is activated by identifying and analyzing inputting a voice message, and the multimedia electronic device can be an iPod player having a storage module stored with a plurality of voice files and has a transmission interface to electrically connect to a voice identification system. The voice identification system is electrically connected to the transmission interface and has a built-in identification module, and a identification unit can identify and analyze the voice signals. An adapting interface is connected to a voice input unit to receive the external voice signal, and thus identify and analyze the external voice signals by the identification module to further activate the multimedia electronic device for playing the voice signal (songs), and select, to adjust and switch the playing content by the inputted external voice signal.

### BACKGROUND OF THE INVENTION

1. Field of the Invention

The present invention relates to an external voice identification system and an identification process thereof, and more particularly a voice identification system for a multimedia electronic device activated by inputting a voice message, with a built-in identification module in the voice identification system to control playing and switching voice file in the multimedia electronic device with the externally inputted voice.

2. Description of Related Art

In the era of the latest technology and unlimited network, audio/video signals of the multimedia can be digitally transmitted and downloaded in a network packet, and the video or voice signals can be downloaded through a legal website and stored into a memory stick, a MP3 (or MP4, MP5) player, an iPod or other multimedia for further playing the voice signals through an external amplifier, a speaker, an acoustic device, an earphone or other megaphone device. However, the user has to use hand to press and control the key, regulator or manual operation interface to switch or select a playing mode while using the common multimedia player. This conventional operation method of the multimedia player is inconvenient for the user and has the following defects.

The multimedia player has to be manual operated for controlling, selecting play mode, switching song or turning on/off, and this manual operation is inconvenient when the user is walking, driving or riding a bicycle or a motorcycle.

The multimedia player is small and has a limited surface, accordingly, the key and the manual operation interface are correspondingly smaller causing the user to press surrounding key instead of pressing the right one while selecting and inputting, and such inconvenience often cause error on selection and input operations.

Therefore, how to overcome the above defect of having operational trouble and mistake while operating, selecting and switching the present multimedia is the target for the manufacturers in the field.

### SUMMARY OF THE INVENTION

An object of the present invention is to provide an external voice identification system and identification process thereof for easy control and operation.

According to an aspect of the present invention, the voice identification system can be electrically connected to a multimedia player (for example an iPod player) having a plurality of voice files stored in a storage module in advance; an external voice identification system having a built-in identification module including an identification unit to identify and analyze an externally inputted voice signal, and a voice inputting unit for receiving the external voice signal for the identification module of the voice identification system to identify and analyze for activating the multimedia electronic device to play the voice file (songs), as well to control and operate for selecting, adjusting, or switching a play content by the external voice input.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram of an external voice identification system according to an embodiment of the present invention.

FIG. 2 is a flowchart illustrating a process for operating an external voice identification system according to an embodiment of the present invention.

FIG. 3 is an elevational view of an external voice identification system according to a preferred embodiment of the present invention.

FIG. 4 is a side view of an external voice identification system according to a preferred embodiment of the present invention.

FIG. 5 is a flowchart of an analysis and identification process of a voice identification module after inputting a voice signal into an external voice identification system according to an embodiment of the present invention.

FIG. 6 is a flowchart of a matching process of a constructive concept script of a voice identification module after inputting a voice signal into an external voice identification system according to an embodiment of the present invention.

### DETAIL DESCRIPTION OF THE INVENTION

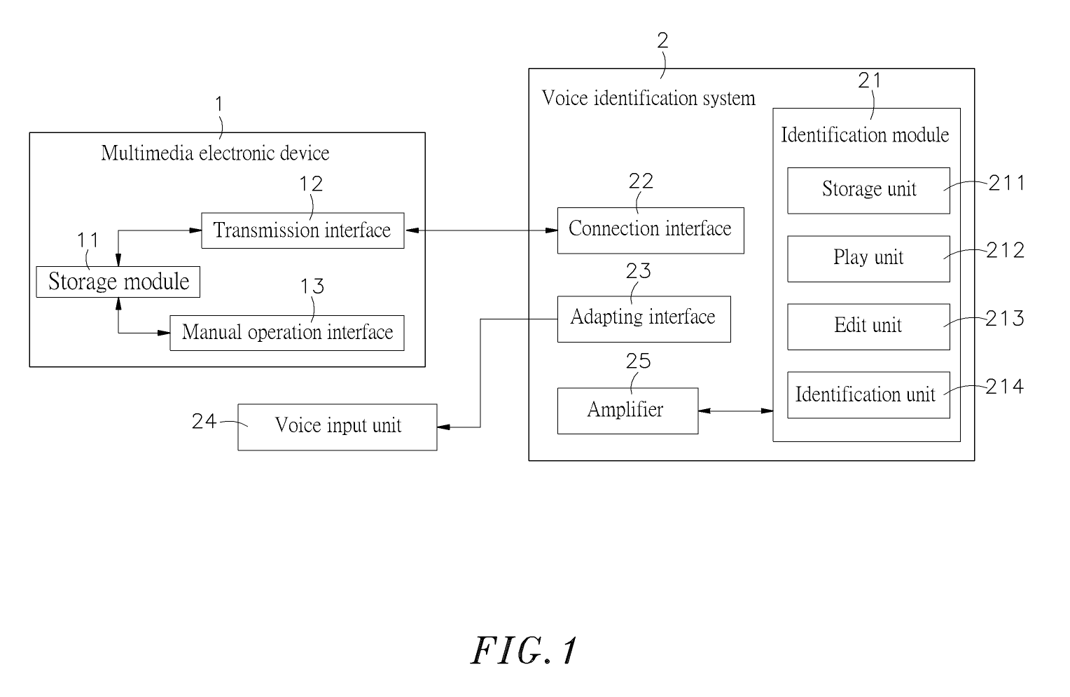

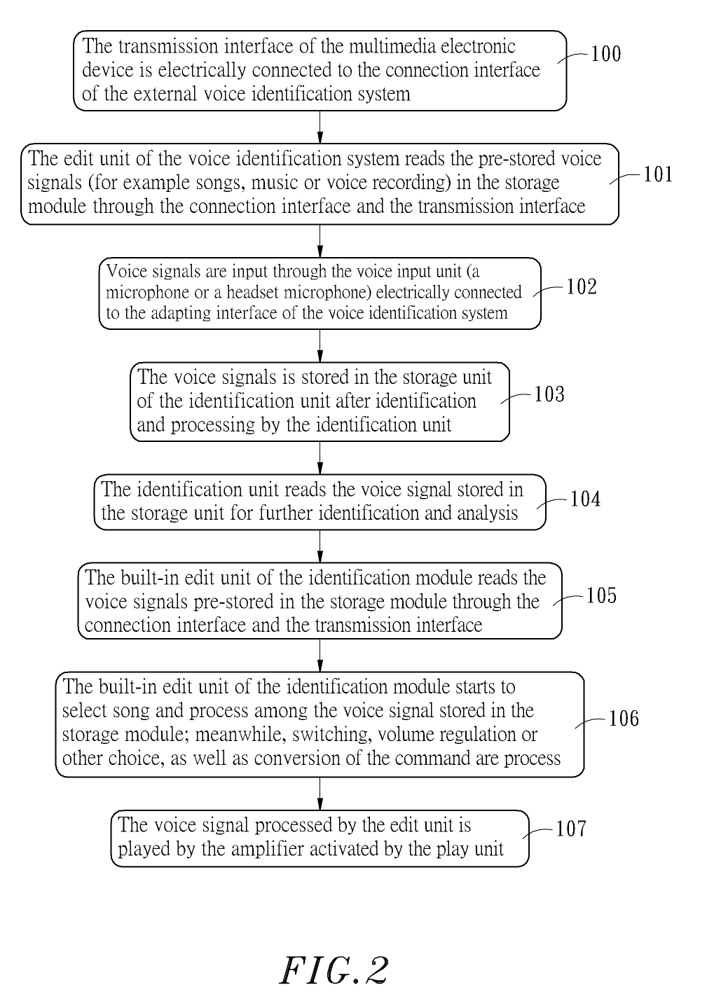

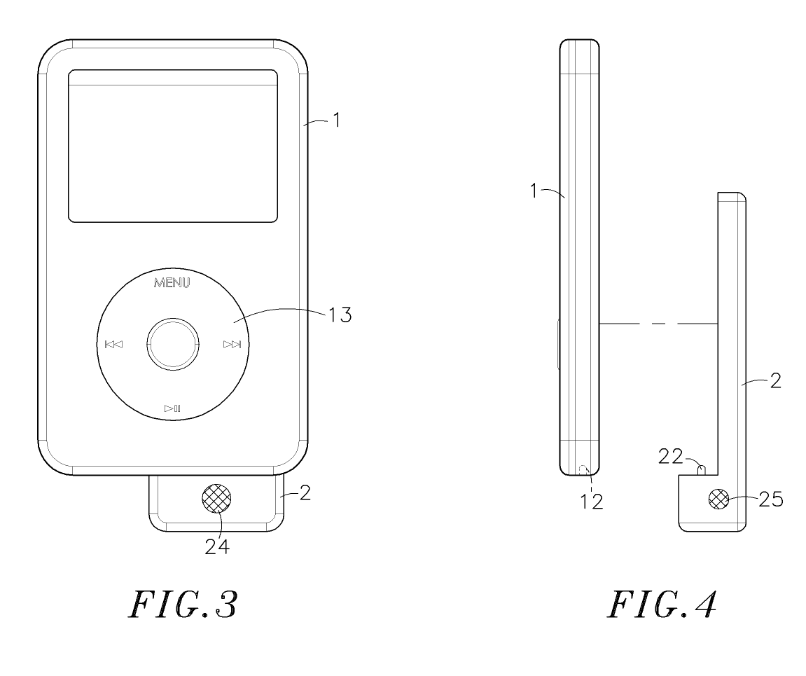

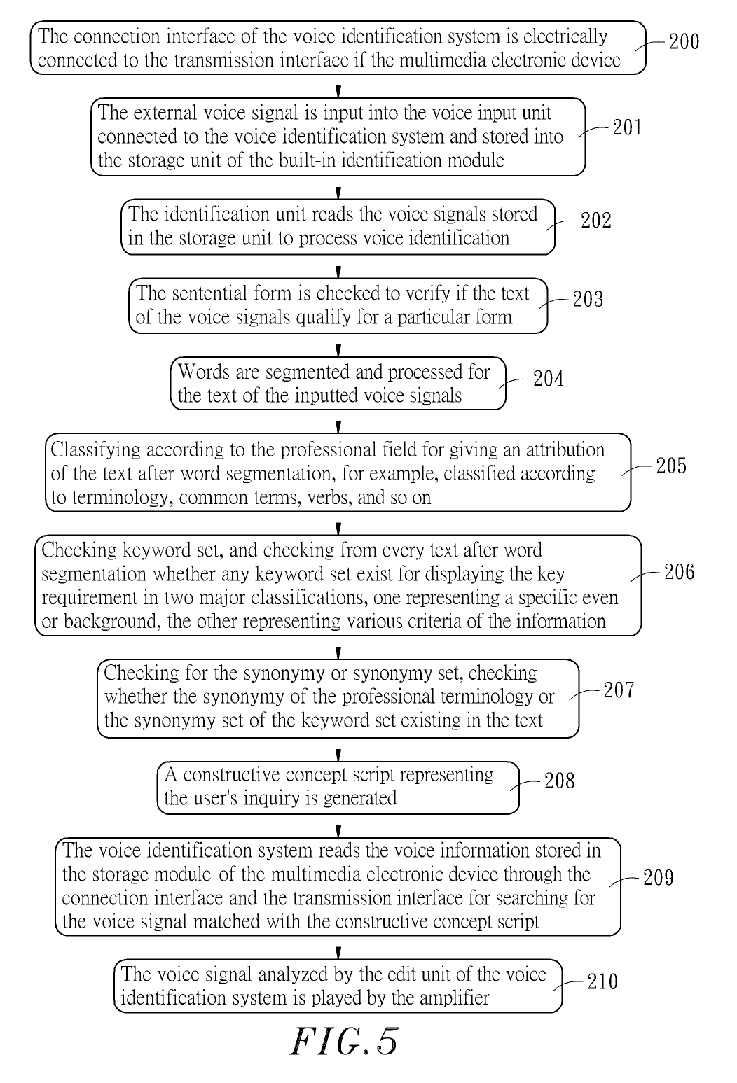

FIG. 1 is a block diagram of an external voice identification system according to an embodiment of the present invention. FIG. 2 is a flowchart illustrating a process for operating an external voice identification system according to an embodiment of the present invention. FIG. 3 is an elevational view of an external voice identification system according to a preferred embodiment of the present invention. FIG. 4 is a side view of an external voice identification system according to a preferred embodiment of the present invention. Referring to FIGS. 1-4, a multimedia electronic device 1 may be an iPod player, a multimedia player or a MP3 player including a built-in storage module 11, a transmission interface 12 and a manual operation interface 13 for controlling a built-in program and editing stored signals.

A voice identification system 2 comprises a built-in identification module 21 for identifying and analyzing a voice. The identification module 21 comprises a built-in storage unit 211 for storing voice signals, a play unit 212 having a built-in play program, an edit unit 213 for editing internal programs and system units or switching the inputted signals, and an identification unit 214 for identifying the voices. The identification module 21 comprises a connection interface 22 and an adapting interface 23, and the adapting interface 23 may be connected to an external voice input unit 24, and also connected to an amplifier 25, for example a speaker, a acoustic device or an earphone for amplifying the sound.

To assemble the above components, a plurality of voice signals (for example songs, music or voice recording) is stored in advance into the internal storage module 11 of the multimedia electronic device 1, and the transmission interface 12 is electrically connected to the connection interface 22 of the voice identification system 2. The multimedia electronic device 1 is activated through the connection interface 22 and transmission interface 12 according to the identified voice signal, and thus enable inputting the voice signals (for example a speaking voice) by the voice input unit 24 to let the built-in identification module 21 to analyze and identify the inputted voice signals, and the built-in storage unit 211 of the identification module 21 stores the voice signal. The identification unit 214 further identifies the voice signal, and the edit unit 213 reads the voice signal pre-stored in the storage module 11 of the multimedia electronic device 1 through the connection interface 22 and the transmission interface 12. Meanwhile, the edit unit 213 selects, switches and edits the voice signals pre-stored in the storage module 11, and the play unit 212 activates the amplifier 25 of the voice identification system 2 to play the voice signal.

The process for inputting and identifying voice according to the present invention is described as follows.

At step 100, the transmission interface 12 of the multimedia electronic device 1 is electrically connected to the connection interface 22 of the external voice identification system 2.

At step 101, the edit unit 213 of the voice identification system 2 reads the pre-stored voice signals (for example songs, music or voice recording) in the storage module 11 through the connection interface 22 and the transmission interface 12.

At step 102, voice signals are input through the voice input unit 24 (a microphone or a headset microphone) electrically connected to the adapting interface 23 of the voice identification system 2.

At step 103, the voice signals are stored in the storage unit 211 of the identification module 21 after identification and processing by the identification unit 214.

At step 104, the identification unit 214 reads the voice signal stored in the storage unit 211 for further identification and analysis.

At step 105, the built-in edit unit 213 of the identification module 21 reads the voice signals pre-stored in the storage module 11 through the connection interface 22 and the transmission interface 12.

At step 106, the built-in edit unit 213 of the identification module 21 starts to select song and process among the voice signal stored in the storage module 11; meanwhile, switching, volume regulation or other choice, as well as conversion of the command are processed.

At step 107, the voice signal processed by the edit unit 213 is played by the amplifier 25 activated by the play unit 212.

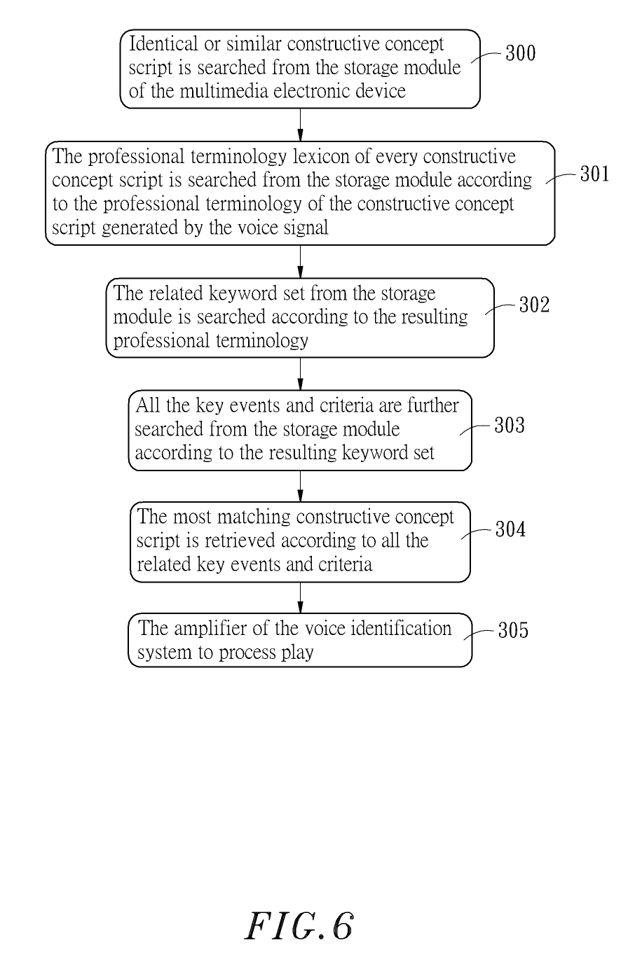

Referring to FIG. 5, an analysis and identification process of the identification unit 214 of the identification module 21 after inputting a voice signal by the voice input unit 24 of the present invention is as the following steps.

At step 200, the connection interface 22 of the voice identification system 2 is electrically connected to the transmission interface 12 of the multimedia electronic device 1.

At step 201, the external voice signal is input into the voice input unit 24 connected to the voice identification system 2 and stored into the storage unit 211 of the built-in identification module 21.

At step 202, the identification unit 214 reads the voice signals stored in the storage unit 211 to process voice identification.

At step 203, the sentential form is checked to verify if the text of the voice signals qualify for a particular form.

At step 204, words are segmented and processed for the text of the inputted voice signals.

At step 205, classifying according to the professional field for giving an attribution of the text after word segmentation, for example, classified according to terminology, common terms, verbs, and so on.

At step 206, checking keyword set, and checking from every text after word segmentation whether any keyword set exist for displaying the key requirement in two major classifications, one representing a specific even or background, the other representing various criteria of the information.

At step 207, checking for the synonymy or synonymy set, checking whether the synonymy of the professional terminology or the synonymy set of the keyword set existing in the text.

At step 208, a constructive concept script representing the user's inquiry is generated.

At step 209, the voice identification system 2 reads the voice information stored in the storage module 11 of the multimedia electronic device 1 through the connection interface 22 and the transmission interface 12 for searching for the voice signal matching with the constructive concept script.

At step 210, the voice signal analyzed by the edit unit 213 of the voice identification system 2 and played by the amplifier 25.

Referring to FIG. 6, after the identification module 21 analyzes the inputted voice signal to generate the constructive concept script, the process of matching with the constructive concept scripts stored in the storage module 11 of the multimedia electronic device 1 is described as follows.

At step 300, identical or similar constructive concept script is searched from the storage module 11 of the multimedia electronic device 1.

At step 301, the professional terminology lexicon of every constructive concept script is searched from the storage module 11 according to the professional terminology of the constructive concept script generated by the voice signal.

At step 302, the related keyword set from the storage module 11 is searched according to the resulting professional terminology.

At step 303, all the key events and criteria are further searched from the storage module 11 according to the resulting keyword set.

At step 304, the most matching constructive concept script is retrieved according to all the related key events and criteria.

At step 305, the amplifier 25 of the voice identification system 2 to process play.

The above the multimedia electronic device 1 may have the plurality of voice signals (for example signals of songs, music or voice recording) stored in the internal storage module 11 through the transmission interface 12 in advance, and the manual operation interface 13 provides to control the built-in programs and system to edit or classify the voice signals (to classify the songs according to titles, artists, albums, languages, for instance Mandarin, Taiwanese or foreign languages). The voice signal is input selected (for instance to input song selection, voice recording, artist name, song title, album title, switching song, and so on) and stored in the storage unit 211 of the identification module 21. The identification unit 214 analyzes the voice signals stored in the storage unit 211 for searching and retrieving the matched item. Furthermore, the amplifier 25 is activated by the play unit 212 for playing the voice signals. The edit unit 213 can switch and select songs, regulate volume and process other functions, and thus rapidly process voice control the voice signals stored in the storage module 11 of the multimedia electronic device 1; instead of manual hand operation, the voice control can overcome the problem of wrong operation or miss pressing the key.

The transmission interface 12 of the multimedia electronic device 1, the connection interface 22 and the adapting interface 23 of the voice identification system 2 may be a connector interface of a USB, SATA or eSATA for transmitting the voice signals.

The above depiction is for illustrating the embodiment of the present invention, and is not intended for limiting the scope of the present invention. The multimedia electronic device 1 may be externally connected to the voice identification system 2 for inputting voice signals into the voice input unit 24 of the voice identification system 2, and stored in the storage unit 211 of the voice identification module 21. After identification and analysis by the identification unit 214, the edit unit 213 reads the voice signals stored in the storage module 11 in advanced, and the play unit 212 activates the amplifier 25 to play the voice signals. Any illustrative or modification shall be construed to be within the scope of the present invention.

The voice identification system and the identification process thereof of the present invention have at least the following advantages.

The multimedia electronic device 1 is externally connected to the voice identification system 2 for inputting voice signals into the voice input unit 24, and the identification module 21 can switch and select songs, regulate volume and process other functions to enable the user to control selection and switching of the multimedia electronic device 1 while walking or moving.

The multimedia electronic device 1 is externally connected to the voice identification system 2 for inputting voice signals without manual operation, and thus miss pressing of key or pressing of the wrong key may be avoided and thereby promote the operation accuracy.

The multimedia electronic device 1 of the prevention has the external voice identification system to input voice for voice controlling the multimedia electronic device 1 is the main feature of the present invention. Any illustrative or modification shall be construed to be within the scope of the present invention.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. An external voice identification system, for a multimedia electronic device activated by inputting a voice message, said multimedia electronic device comprising:
a built-in storage module for storing voice signals;
a manual operation interface for controlling built-in programs; and
a transmission interface for transmitting external voice signals;
said external voice identification system comprising:
a connection interface electrically connected to said transmission interface;
an identification module for identifying, analyzing and processing external voice signals; and
an identification unit, connected to said multimedia electronic device through said connection interface and said transmission interface for identifying signals, comprising a voice input unit for receiving external voice signals and an amplifier for playing said voice signals.

2. The external voice identification system according to claim 1, wherein said multimedia electronic device comprises a player of an iPod (a digital multimedia player), a MP3, MP4 or MP5.

3. The external voice identification system according to claim 1, wherein said transmission interface of said multimedia electronic device comprises a connector interface of a USB, SATA or eSATA.

4. The external voice identification system according to claim 1, wherein said voice identification system comprises said built-in identification module, and said identification module comprises a play unit, a storage unit and an edit unit.

5. The external voice identification system according to claim 1, wherein said voice input unit of said voice identification system comprises a microphone or an earphone.

6. The external voice identification system according to claim 1, wherein said voice identification system comprises an adapting interface for electrically connecting to said voice input unit, and said adapting interface comprises an interface of a voice connector, a USB connector, a SATA or an eSATA connector.

7. An identification process for an external voice identification system for analyzing an inputted external voice signal, comprising:
(a1) electrically connecting said external voice identification system to a multimedia electronic device;
(a2) inputting said external voice signal into a voice input unit connected to said external voice identification system, and storing said voice signal into a storage unit through a built-in identification module;
(a3) reading said voice signal stored in said storage unit by said identification unit for further identification;
(a4) checking sentential forms, and verifying whether texts of the voice signals qualify for a particular form;
(a5) segmenting words, processing segmentation for texts of said inputted voice signals;
(a6) classifying according to a professional field for giving an attribution of said text after word segmentation to classify as terminologies, common terms or verbs;
(a7) checking keyword set, and checking from every text after word segmentation whether any keyword set exist for displaying a key requirement in two major classifications, one representing a specific even or background, another representing various criteria of information;
(a8) checking for a synonymy or a synonymy set, and checking whether said synonymy of a professional terminology or said synonymy set of a keyword set exist in said text;
(a9) generating a constructive concept script representing a user's inquiry;
(a10) said voice identification system reading a voice information stored in said multimedia electronic device matching with said constructive concept script; and
(a11) analyzing using an edit unit of said voice identification system and playing using an amplifier.

8. The identification process for an external voice identification system according to claim 7, for matching said constructive concept script, comprising:
(b1) searching for an identical or similar constructive concept script from said storage module of said multimedia electronic device;
(b2) searching a professional terminology lexicon of every constructive concept script from said storage module according to said professional terminology of said constructive concept script generated by said voice signal;
(b3) searching for a related keyword set from said storage module according to said resulting professional terminology;
(b4) searching for all key events and criteria from said storage module according to said related keyword set;
(b5) retrieving a most matching constructive concept script according to all related key events and criteria; and
(b6) playing through said amplifier of said external voice identification system.
